(19) United States
(12) Patent Application Publication
(10) Pub. No.: US 2024/0020754 A1
(43) Pub. Date: Jan. 18, 2024

(54) INFORMATION PROCESSING APPARATUS, INFORMATION PROCESSING METHOD, AND SYSTEM

(71) Applicant: TOYOTA JIDOSHA KABUSHIKI KAISHA, Aichi-ken (JP)

(72) Inventors: Hiroyuki OKAWARA, Nagoya-shi (JP); Masafumi FUJIO, Kobe-shi (JP); Koji TAKAHASHI, Tokyo (JP); Sho KOBAYASHI, Nagoya-shi (JP); Takahiro ICHINOSE, Nagoya-shi (JP)

(21) Appl. No.: 18/350,749

(22) Filed: Jul. 12, 2023

(30) Foreign Application Priority Data
Jul. 14, 2022 (JP) 2022-113069

(51) Int. Cl. G06Q 30/0645; G06Q 30/0283

(52) U.S. Cl. CPC G06Q 30/0645; G06Q 30/0283

(57) ABSTRACT

A controller is provided which is configured to: output, as lease plans for a new vehicle, a first plan in which an initial cost is incurred but a premature cancellation fee is not incurred and a second plan in which an initial cost is not incurred but a premature cancellation fee is incurred; and output only the first plan as a lease plan for a used vehicle.

### CROSS REFERENCE TO THE RELATED APPLICATION

This application claims the benefit of Japanese Patent Application No. 2022-113069, filed on Jul. 14, 2022, which is hereby incorporated by reference herein in its entirety.

### BACKGROUND

### Technical Field

The present disclosure relates to an information processing apparatus, an information processing method, and a system.

### Description of the Related Art

There has been known a technique in which a lease fee for each unit period (e.g., each month) is calculated based on a total lease amount and a scheduled lease period (see, for example, Patent Literature 1).

### CITATION LIST

### Patent Literature

Patent Literature 1: Japanese Patent Application Laid-Open Publication No. 2022-067192

### SUMMARY

If a user attempts to cancel a lease before the expiration of a contract period thereof, a cancellation fee will be incurred, and hence, the user with a contract for a used vehicle lease tends to continue to use the same vehicle without canceling the lease until the contract period expires. The object of the present disclosure is to promote the replacement of vehicles before the expiration of a contract period in used vehicle leasing.

One aspect of the present disclosure is directed to an information processing apparatus comprising a controller configured to:
output, as lease plans for a new vehicle, a first plan in which an initial cost is incurred but a premature cancellation fee is not incurred and a second plan in which an initial cost is not incurred but a premature cancellation fee is incurred; and
output only the first plan as a lease plan for a used vehicle.

Another aspect of the present disclosure is directed to an information processing method comprising:
outputting, by a computer, as lease plans for a new vehicle, a first plan in which an initial cost is incurred but a premature cancellation fee is not incurred and a second plan in which an initial cost is not incurred but a premature cancellation fee is incurred; and
outputting only the first plan as a lease plan for a used vehicle.

A further aspect of the present disclosure is directed to a system comprising:
a terminal of a user; and
a server including a controller configured to transmit lease plans for a new vehicle or a lease plan for a used vehicle to the terminal of the user;
wherein the controller is configured to:
transmit, as the lease plans for the new vehicle, to the user terminal a first plan in which an initial cost is incurred but a premature cancellation fee is not incurred, and a second plan in which an initial cost is not incurred but a premature cancellation fee is incurred; and
transmit, as the lease plan for the used vehicle, only the first plan to the user terminal.

In addition, a still further aspect of the present disclosure is directed to a program for causing a computer to perform processing in the above-mentioned information processing apparatus or system, or a storage medium storing the program in a non-transitory manner.

According to the present disclosure, it is possible to promote the replacement of vehicles before the expiration of a contract period in used vehicle leasing.

### BRIEF DESCRIPTION OF THE DRAWINGS

FIG. 1 is a view illustrating a schematic configuration of a system according to an embodiment;

FIG. 2 is a block diagram schematically illustrating an example of a configuration of each of a server, a user terminal and a facility terminal, which together constitute the system according to the embodiment;

FIG. 3 is a diagram illustrating an example of a functional configuration of the server;

FIG. 4 is a view schematically illustrating a residual value table for explanation;

FIG. 5 is a view illustrating an example of a table configuration of market information stored in a market information DB;

FIG. 6 is a view illustrating an example of a table configuration of residual value information stored in a residual value information DB;

FIG. 7 is a view illustrating a monthly fee correspondence table;

FIG. 8 is a diagram illustrating an example of a functional configuration of the user terminal;

FIG. 9 is a diagram illustrating an example of a functional configuration of the facility terminal;

FIG. 10 is a sequence diagram illustrating processing for generating the residual value table;

FIG. 11 is a sequence diagram illustrating the processing of the system when a user accesses a lease site;

FIG. 12 is a view illustrating an example of a page for allowing the user to select either a new vehicle or a used vehicle;

FIG. 13 is a view illustrating an example of a page for allowing the user to select a vehicle type;

FIG. 14 is a view illustrating an example of an image shown on a display of the user terminal when the user selects the new vehicle;

FIG. 15 is a view illustrating an example of an image shown on the display of the user terminal when the user selects the used vehicle;

FIG. 16 is a flowchart of processing for displaying fee plans on the display of the user terminal according to a first embodiment;

FIG. 17 is a view illustrating an example of a web page shown on the display of the user terminal for selecting a fee plan;

FIG. 18 is a flowchart of processing for displaying fee plans on the display of the user terminal according to a second embodiment;

FIG. 19 is a flowchart of processing for displaying fee plans on the display of the user terminal according to a third embodiment;

FIG. 20 is a view illustrating an example of a page for allowing a user to select, as a fee plan, either a first plan (cancellation fee free plan) or a second plan (initial cost free plan);

FIG. 21 is a view illustrating an example of an image shown on the display of the user terminal when the user selects the first plan; and

FIG. 22 is a view illustrating an example of an image shown on the display of the user terminal when the user selects the second plan.

### DESCRIPTION OF THE EMBODIMENTS

An information processing apparatus, which is one aspect of the present disclosure, is an information processing apparatus that outputs lease plans for a new vehicle and a used vehicle. The new vehicle is a vehicle that has never been registered or a vehicle that has never been used. The used vehicle is a vehicle that has been registered as a vehicle at least once before or a vehicle that has a history of having been used before. The used vehicle includes a vehicle that was used as a lease vehicle in the past. In this case, the lease vehicle will be re-leased. The lease plans include plans regarding the fees to be paid by a user.

In addition, the information processing apparatus including a controller configured to: output, as lease plans for a new vehicle, a first plan in which an initial cost is incurred but a premature cancellation fee is not incurred and a second plan in which an initial cost is not incurred but a premature cancellation fee is incurred; and output only the first plan as a lease plan for a used vehicle. For example, when making a lease contract for a vehicle, the user can select either a new vehicle or a used vehicle. For example, in cases where the user selects a new vehicle, the first plan and the second plan are presented to the user, whereas in cases where the user selects a used vehicle, only the first plan is presented to the user.

The first plan is a plan in which an initial cost is incurred and a premature cancellation fee is not incurred. The initial cost is a fee that the user is required to pay first at the time of signing the lease contract. The initial cost is also a fee to be paid separately from the fee that the user pays at predetermined intervals (e.g., a monthly lease fee). The user can make a contract for the first plan subject to the payment of the initial cost. In addition, the premature cancellation fee is a fee that is required to be paid when the user cancels or terminates the lease before the expiration of the lease contract period. The user does not have to pay the premature cancellation fee at the time of canceling the first plan. Otherwise, for example, the user is required to pay a monthly fee corresponding to the first plan every month.

The second plan is a plan in which an initial cost is not incurred and a premature cancellation fee is incurred. Therefore, the user does not have to pay the initial cost at the time of contracting for the second plan. On the other hand, the user needs to pay the premature cancellation fee at the time of making a premature termination in the second plan. Otherwise, for example, the user is required to pay a monthly fee corresponding to the second plan every month.

Here, if the second plan is set up in a used vehicle lease, the user will have to pay a premature cancellation fee in the case of terminating the lease before the end of the term. Since many users who lease used vehicles are attracted to low fees to be paid monthly, they feel that the premature cancellation fee is a significant burden. Therefore, even if a user wants to change to another vehicle, he or she will have to endure and continue to drive the same vehicle until the contract expires. This would not promote the change of vehicles.

Therefore, in cases where the user selects a used vehicle, the controller outputs only the first plan in which no premature cancellation fee is incurred. As a result, it becomes easier for the user to cancel the lease contract prematurely, thus making it easier for the user to change to the next vehicle. For example, if there are users who change from a used vehicle lease to a new vehicle lease, more revenue can be generated. In addition, for the users, too, it is possible to easily change their vehicles, so that the users can experience more vehicles.

In addition, the controller may also set a difference between the amount to be paid at predetermined intervals (i.e., every predetermined period) in the first plan corresponding to a new vehicle and the amount to be paid at the predetermined intervals in the first plan corresponding to a used vehicle to a fixed amount of difference, regardless of the type of vehicle (hereinafter, also referred to as vehicle type). The amount to be paid at predetermined intervals is, for example, a monthly fee, and is a fee that the user regularly pays. This payment may be made, for example, by debiting a bank account or by credit card payment. The predetermined intervals (i.e., predetermined period) can be set as appropriate. The vehicle type may be the model of vehicle or the name of vehicle. The fixed amount of difference regardless of the vehicle type means that the difference in amount of payment between a new vehicle and a used vehicle becomes equal for any type of vehicles. This means, for example, that the difference in amount of payment between the new and used vehicles of a first vehicle type is equal to the difference in amount of payment between the new and used vehicles of a second vehicle type different from the first vehicle type. In this way, by setting the amount of payment for the first plan corresponding to the used vehicle based on a comparison with the new vehicle, the setting of fees becomes simple and easy for the user to understand. In addition, by setting the fixed amount of difference in such a manner that the amount of payment for the used vehicle is lower than the monthly fee of the new vehicle, it becomes easier for the user to select the used vehicle.

Moreover, the controller may also set a difference between the amount to be paid at predetermined intervals in the first plan corresponding to a new vehicle and the amount to be paid at the predetermined intervals in the first plan corresponding to a used vehicle to a fixed amount of difference, regardless of the type of vehicle but according to the class (rating) of vehicle (hereinafter, vehicle class). The vehicle class is a classification of the size of a vehicle based on a predetermined standard. For example, the classification may be based on overall length, overall width, wheelbase, or the like. For example, vehicles may be classified into compact class, middle class, large class, or the like. In addition, the vehicle class can also be classified by the price of the vehicle when it was new, the displacement of the engine, the output of the motor, or the like. Here, relatively large vehicles tend to have higher selling prices for new vehicles than relatively small vehicles. If the payment for used vehicles is calculated by subtracting the difference from the payment for new vehicles (e.g., monthly fee) while the same difference is set for higher-priced vehicles and lower-priced vehicles, the ratio of the payment for the used vehicles to the payment for the new vehicles will be different between the higher-priced vehicles and the lower-priced vehicles. In this case, for example, in vehicles of a larger vehicle class, the degree of decrease in the amount of payment for used vehicles becomes smaller as compared with the amount of payment for new vehicles, and hence the attractiveness of the used vehicles can be felt small. On the other hand, in the case of vehicles of a smaller vehicle class, the degree of decrease in the amount of payment for used vehicles increases, and there is a concern that profits cannot be secured for the used vehicles. On the other hand, by setting the difference between the amount of payment for the first plan corresponding to new vehicles and the amount of payment for the first plan corresponding to used vehicles to the fixed amount of difference that does not depend on the vehicle type but depends on the vehicle class, the attractiveness of the used vehicles can be increased for vehicles of a larger vehicle class, and profits in the used vehicles can be secured for vehicles of a smaller vehicle class. Here, note that the fixed amount of difference may be set for each vehicle class so that the ratio of the amount of payment for the used vehicles at predetermined intervals to the amount of payment for the new vehicles at the predetermined intervals is within a predetermined range.

Further, the controller may also set a difference between the amount to be paid at predetermined intervals in the first plan corresponding to a new vehicle and the amount to be paid at the predetermined intervals in the first plan corresponding to a used vehicle to a fixed amount of difference, regardless of the vehicle type but according to the model year. The model year of a vehicle may be the year in which the vehicle was manufactured or the year in which the vehicle was first registered. Here, even for the same vehicle type, the older the model year, i.e., the more years elapsed since the year the vehicle was first registered, the less attractive the used vehicle becomes. Therefore, if the same price is set for different model years, the demand for used vehicles of older model years will decrease. On the other hand, by setting the amount of payment according to the model year, it is possible to increase the attractiveness of used vehicles of older model years. In addition, in used vehicles of newer model years, it becomes possible to obtain more profits.

Therefore, the controller may increase the fixed amount of difference as the model year of the used vehicle is older, in the case of the same vehicle type in the first plan corresponding to the used vehicle.

In addition, the controller may also output the first plan in the new vehicle and the first plan in the used vehicle, by setting as a residual value a price of each vehicle at the expiration of a lease contract, and calculating and outputting a fee in each of the first plan in the new vehicle and the first plan in the used vehicle based on the same residual value setting for the new vehicle and the used vehicle. In this way, by making the same residual value setting for the new vehicle and the used vehicle, it is possible to calculate the fees for leasing in an easy manner. Also, by setting the residual value, the monthly fees can be kept low, for example. The residual value is set based on the prediction of the price of each vehicle at the expiration of the contract.

Moreover, the controller may also set the same fee, in the case of the same vehicle type in the first plan corresponding to the used vehicle, regardless of the condition of the used vehicle. The condition of the used vehicle can include the traveling distance (mileage) of the used vehicle and the state of deterioration of the used vehicle. As a result, for example, it becomes easy to set the monthly fee. However, if the same fee is applied to vehicles whose traveling distance is too long or vehicles which have deteriorated to such an extent that they no longer function as used vehicles, users will be dissatisfied. Therefore, only vehicles whose traveling distance is equal to or less than a predetermined distance or only used vehicles whose deterioration is within an allowable range may be selected as targets for leasing.

Further, a memory may be further provided which is configured to store: a residual value for predicting a future valuation corresponding to the new vehicle; a calculation formula for calculating, based on the residual value, a fee in the first plan and a fee in the second plan, both corresponding to the new vehicle; and information about a difference between the fee for the first plan corresponding to the new vehicle and the fee for the second plan corresponding to the used vehicle. Since the memory stores the residual value, the calculation formula, and the difference, it is possible to quickly calculate the fee corresponding to the new vehicle and the fee corresponding to the used vehicle. Therefore, it is possible to quickly output information about fee plans. Here, note that the calculation formula may be a model. In this way, for example, monthly fees can be quickly presented to the user. The memory may store, for example, a residual value table that represents residual values corresponding to the number of months elapsed since the registration of a new vehicle for each vehicle type.

In addition, a communication unit may be further provided which communicates with a terminal of a user, wherein the control unit may be configured to: output the first plan and the second plan by transmitting, in response to receiving a request to display lease plans from the terminal of the user via the communication unit, a command to display, as lease plans for the new vehicle, an image corresponding to the first plan and the second plan on the terminal of the user, to the terminal of the user via the communication unit; and output only the first plan by transmitting to the terminal of the user via the communication unit a command to display, as a lease plan for the used vehicle, an image corresponding to only the first plan on the terminal of the user.

Also, a communication unit may be further provided which communicates with a terminal of a user, wherein the controller may be configured to: transmit, in response to receiving a request to display a lease plan from the terminal of the user, to the terminal of the user a command to display, on the terminal of the user, an image that allows the user to select a lease of either the new vehicle or the used vehicle, and a command to transmit information about the selection of the lease entered by the user into the terminal of the user; calculate, in response to receiving information about the user's selection of the lease of the new vehicle from the terminal of the user, a fee corresponding to the new vehicle for each of the first plan and the second plan based on the residual value and the calculation formula stored in the memory; output the first plan and the second plan by transmitting, to the terminal of the user, a command to display, on the terminal of the user, an image corresponding to the calculated fee for each of the first plan and the second plan; calculate, in response to receiving information about the user's selection of the lease of the used vehicle from the terminal of the user, a fee corresponding to the new vehicle for the first plan based on the residual value and the calculation formula stored in the memory; calculate a fee corresponding to the used vehicle for the first plan based on the calculated fee corresponding to the new vehicle and the information about the difference stored in the memory; and output only the first plan by transmitting, to the terminal of the user, a command to display, on the terminal of the user, an image corresponding to the calculated fee for the first plan.

In the terminal of the user, for example, when accessing a lease site or when a predetermined button for displaying lease plans at a lease site is tapped, a request for displaying lease plans is transmitted. In response to this lease request, the controller outputs lease plans.

Moreover, the communication unit may be further configured to communicate with a terminal that manages the buying and selling of the used vehicle.

The memory may be further configured to store first information about a transaction amount of the used vehicle received from the terminal that manages the buying and selling of the used vehicle, and a second calculation formula for calculating, as residual values, predicted values of prices of the new vehicle and the used vehicle based on the first information.

The controller may be configured to:
receive the first information from the terminal that manages the buying and selling of the used vehicle, to store the first information thus received in the memory;
calculate the residual values based on the first information and the second calculation formula; and
store the residual values thus calculated in the memory.

By calculating the residual values based on the transaction amount of the used vehicle, it is possible to calculate appropriate residual values. In this case, the second calculation formula is used to calculate the residual values, which makes it easy to calculate the residual values. Then, by storing the residual values in the memory, it is possible to quickly calculate a fee corresponding to the new vehicle and a fee corresponding to the used vehicle by using the residual values. Therefore, fee plans can be quickly presented to the user.

Hereinafter, embodiments of the present disclosure will be described based on the accompanying drawings. The configurations of the following embodiments are examples, and the present disclosure is not limited to the configurations of the embodiments. In addition, the following embodiments can be combined with one another as long as such combinations are possible and appropriate.

### First Embodiment

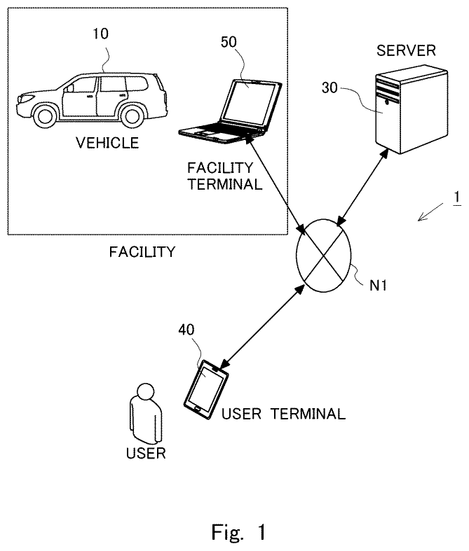

FIG. 1 is a view illustrating a schematic configuration of a system 1 according to an embodiment. In the example of FIG. 1, the system 1 includes a server 30, a user terminal 40, and a facility terminal 50. The system 1 is a system in which the server 30 presents a rate or fee plan according to a vehicle 10 when a user concludes a lease contract for the vehicle 10 via the user terminal 40. The server 30 is a computer that provides online a lease service for a new vehicle or a used vehicle. The user that uses the online lease service accesses a lease site (a website for leasing the vehicle 10) through a web browser of the user terminal 40 to apply for the leasing of the vehicle 10. The vehicle 10 is a new vehicle or a used vehicle. The used vehicle includes a previously leased vehicle and a rented vehicle.

Here, note that a facility in FIG. 1 is a place or location, such as an automobile dealer, an auction site or the like, from which information about the vehicle 10 can be obtained. In the facility, for example, cleaning and assessment of a used vehicle that may be a target of leasing is performed. In addition, the facility terminal 50 obtains the condition of the vehicle 10, the winning bid price of the auction, and the like. This facility terminal 50 may be a terminal that manages the auction. Here, note that in the present embodiment, it is assumed that the vehicle 10 to be leased is assessed and cleaned at a facility serving as an auction site. Therefore, in cases where the assessment and the cleaning of the vehicle 10 to be leased are performed at locations other than the auction site, terminals may be provided at the respective locations.

The condition of the vehicle 10 may be a score or rating obtained as a result of the assessment. The assessment is made by an assessor of the facility, and the assessor enters the result of the assessment into the facility terminal 50. In addition, the condition of the vehicle 10 and the winning bid price of the vehicle 10 are transmitted from the facility terminal 50 to the server 30, so that the server 30 accumulates information about the state and the winning bid price of the vehicle 10. Based on this accumulated information, the server 30 can determine the market price of the vehicle 10. The server 30 generates a residual value table for the vehicle 10 based on the market price of the vehicle 10. Lease fees are set based on this residual value table. Here, note that a vehicle 10 which is won or sold at the auction is a vehicle that will be picked up and sold, etc., at its winning bid price, and thus is not subject to a lease contract. On the other hand, a lease vehicle is a vehicle which is assessed and cleaned at the facility, but is not subject to auction. Since the winning bid price at the auction is used to calculate the remaining price of the lease vehicle, both information about the lease vehicle and information about the vehicle that has been won at the auction are transmitted from the facility terminal 50 to the server 30.

The server 30 presents fee plans to the user via, for example, a website on the Internet, and then makes a lease contract based on the selection of the user. In this embodiment, the server 30 is configured to be able to run a web server for interacting with the user terminal 40. When the user accesses the web server through the browser of the user terminal 40, the server 30 displays on the browser of the user terminal 40 a web page of a site for presenting a fee plan corresponding to a new vehicle or a fee plan corresponding to a used vehicle. When the server 30 receives from the user terminal 40 a request to make a lease contract for the vehicle 10 displayed on the web page, the server 30 performs processing for the lease contract.

The user terminal 40 is a computer used by the user who uses the lease site. A web browser, for example, is installed in the user terminal 40. Using this web browser, the user concludes a lease contract for the vehicle 10 from the user terminal 40. Note that the conclusion of the lease contract is not limited to the web browser, but may be executed by using other application software. Upon concluding the lease contract, one or more lease plans are presented from the server 30 to the user terminal 40. At this time, in the case of a new vehicle lease, a first plan and a second plan are presented, whereas in the case of a used vehicle lease, only the first plan is presented.

The server 30, the user terminal 40, and the facility terminal 50 are connected to one another via a network N1. Here, note that the network N1 is, for example, a worldwide public communication network such as the Internet or the like, and a WAN (Wide Area Network) or other communication networks may be adopted. Also, the network N1 may include a telephone communication network such as a mobile phone network or the like, and/or a wireless communication network such as Wi-Fi (registered trademark) or the like.

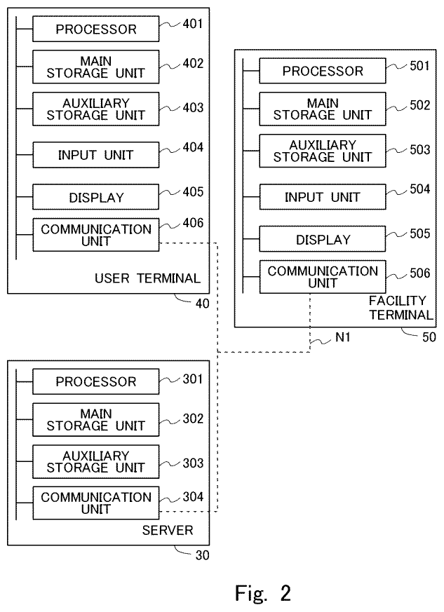

Next, hardware configurations of the server 30, the user terminal 40, and the facility terminal 50 will be described based on FIG. 2. FIG. 2 is a block diagram schematically illustrating an example of a configuration of each of the server 30, the user terminal 40 and the facility terminal 50, which together constitute the system 1 according to the embodiment.

The server 30 has a configuration of a computer. The server 30 provides a lease service to the user. The server 30 includes a processor 301, a main storage unit 302, an auxiliary storage unit 303, and a communication unit 304. These components are mutually connected to one another by means of a bus. Note that the server 30 is an example of an information processing apparatus. Also, the processor 301 is an example of a controller. In addition, the main storage unit 302 and the auxiliary storage unit 303 are examples of a storage unit.

The processor 301 is a CPU (Central Processing Unit), a DSP (Digital Signal Processor), or the like. The processor 301 controls the server 30 thereby to perform various information processing operations. The main storage unit 302 is a RAM (Random Access Memory), a ROM (Read Only Memory), or the like. The auxiliary storage unit 303 is an EPROM (Erasable Programmable ROM), a hard disk drive (HDD), a removable medium, or the like. The auxiliary storage unit 303 stores an operating system (OS), various programs, various tables, and the like. The processor 301 loads a program stored in the auxiliary storage unit 303 into a work area of the main storage unit 302 and executes the program, so that each component or the like is controlled through the execution of the program. As a result, the server 30 realizes functions that match predetermined purposes. The main storage unit 302 and the auxiliary storage unit 303 are computer readable recording media. Here, note that the server 30 may be a single computer or a plurality of computers that cooperate with one another. In addition, the information stored in the auxiliary storage unit 303 may be stored in the main storage unit 302. Also, the information stored in the main storage unit 302 may be stored in the auxiliary storage unit 303.

The communication unit 304 is a means or unit that communicates with the user terminal 40 and the facility terminal 50 via the network N1. The communication unit 304 is, for example, a LAN (Local Area Network) interface board, a wireless communication circuit for wireless communication, or the like. The LAN interface board or the wireless communication circuit is connected to the network N1.

Now, the user terminal 40 will be described. The user terminal 40 is, for example, a smart phone, a mobile phone, a tablet terminal, a personal information terminal, a wearable computer (such as a smart watch or the like), or a small computer such as a personal computer (PC).

The user terminal 40 includes a processor 401, a main storage unit 402, an auxiliary storage unit 403, an input unit 404, a display 405, and a communication unit 406. These components are mutually connected to one another by means of a bus. The processor 401, the main storage unit 402 and the auxiliary storage unit 403 of the user terminal 40 are the same as the processor 301, the main storage unit 302 and the auxiliary storage unit 303 of the server 30, respectively, and hence, the description thereof will be omitted.

The input unit 404 is a means or unit that receives an input operation performed by the user, and is, for example, a touch panel, a mouse, a keyboard, a microphone, or the like. The display 405 is a means or unit that presents information to the user, and is, for example, an LCD (Liquid Crystal Display), an EL (Electroluminescence) panel, or the like. Note that the input unit 404 and the display 405 may be configured as a single touch panel display.

The communication unit 406 is a communication means or unit that connects the user terminal 40 to the network N1. The communication unit 406 is, for example, a circuit that communicates with other devices (e.g., the server 30 and the like) via the network N1 by making use of a mobile communication service (e.g., a telephone communication network such as 6G (6th Generation), 5G (5th Generation), 4G (4th Generation), 3G (3rd Generation), or LTE (Long Term Evolution)) or a wireless communication network such as Wi-Fi (registered trademark) or the like.

Next, the facility terminal 50 will be described. The facility terminal 50 is a smart phone, a mobile phone, a tablet terminal, a personal information terminal, a wearable computer (such as a smart watch or the like), or a computer such as a personal computer (PC).

The facility terminal 50 includes a processor 501, a main storage unit 502, an auxiliary storage unit 503, an input unit 504, a display 505, and a communication unit 506. These components are mutually connected to one another by means of a bus. The processor 501, the main storage unit 502, the auxiliary storage unit 503, the input unit 504, the display 505, and the communication unit 506 of the facility terminal 50 are the same as the processor 401, the main storage unit 402, the auxiliary storage unit 403, the input unit 404, the display 405, and the communication unit 406 of the user terminal 40, respectively, and hence, the description thereof will be omitted.

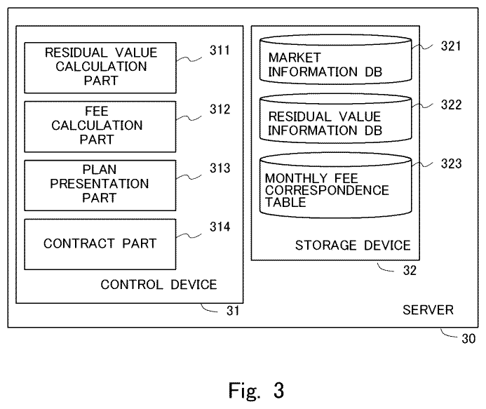

Then, the functions of the server 30 will be described. FIG. 3 is a diagram illustrating an example of a functional configuration of the server 30. The server 30 includes, as its functional components, a control device 31 and a storage device 32. The processor 301 of the server 30 executes the processing of the control device 31 by means of a computer program on the main storage unit 302. Note that a part of the processing of the control device 31 may be executed by another or other computers connected to the network N1. The control device 31 includes, as functional modules, a residual value calculation part 311, a fee calculation part 312, a plan presentation part 313, and a contract part 314.

In addition, the storage device 32 is configured to include the main storage unit 302 and the auxiliary storage unit 303. In the storage device 32, there are stored a market information DB 321, a residual value information DB 322, and a monthly fee correspondence table 323. The market information DB 321 and the residual value information DB 322 are, for example, relational databases that are built by a program of a database management system (DBMS) executed by the processor 301 to manage data stored in the auxiliary storage unit 303.

The residual value calculation part 311 calculates a residual value of the vehicle 10 and generates a residual value table. The residual value is a valuation of the vehicle 10 after a predetermined period has elapsed. The residual value table is a table that stores the predicted value of the residual value of the vehicle 10 corresponding to the elapsed months from the new vehicle registration. The residual value calculation part 311 calculates the transition of the future residual value as a predicted value to generate the residual value table.

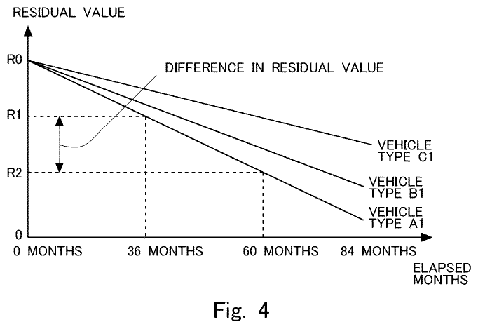

FIG. 4 is a view schematically illustrating the residual value table for explanation. In the residual value table illustrated in FIG. 4, the horizontal axis represents the elapsed months from the new vehicle registration, and the vertical axis represents the residual value. Here, the residual value of the vehicle 10 will be described. The valuation at the time of selling the vehicle 10 may vary depending on the type of the vehicle and the elapsed months from the new vehicle registration. The residual value table shows the transition of the valuation from the time of registration of the new vehicle 10, and for example, the longer the elapsed months, the lower the residual value becomes. In FIG. 4, “0 MONTHS” indicates the time of registration of each new vehicle, at which time, for example, the residual values of vehicle type A1, vehicle type B1, and vehicle type C1 are the same at R0. R0 may be considered as a selling price of each new vehicle. However, since the market price of each vehicle in the used vehicle market change according to the degree of popularity of each vehicle type or the like, the degree of decline of each vehicle in the residual value may change for each vehicle type. Therefore, the residual value calculation part 311 sets a residual value table according to the market price of each vehicle in the used vehicle market for each vehicle type. Note that the method of calculating the residual value corresponding to the number of months elapsed since the sale of the new vehicle is not limited. Known techniques can be used to calculate the residual value. For example, a calculation formula to calculate the residual value from the winning bid price of the auction or a calculation formula to generate the residual value table from the winning bid price at the auction is stored in the auxiliary storage unit 303. In addition, since the valuation of the used vehicle may vary depending on optional items or the like installed on the vehicle 10, the residual value table may be set for each vehicle 10 of the same grade equipped with the same optional items. Then, the residual value table is updated as appropriate according to the winning bid price at the auction.

In this way, the residual value table shows the relationship between the number of months elapsed and the residual value for each vehicle type. This residual value table is set based on the price at the time of new vehicle registration. That is, the residual value table is set based on the new vehicle. Then, in the present embodiment, the residual value of the used vehicle is also calculated by using the residual value table based on the price at the time of new vehicle registration. In other words, the same residual value table is used for the new and used vehicles. Then, based on the same residual value setting for the new vehicle and the used vehicle, the fees for the first plan in the new vehicle, the second plan in the new vehicle, and the first plan in the used vehicle are calculated.

In the example illustrated in FIG. 4, vehicle type A1 has the largest rate of fall of the residual value, and vehicle type C1 has the smallest rate of fall of the residual value. Here, note that in FIG. 4, the residual value table is set so that the residual value falls linearly, but the present invention is not limited to this, and for example, the residual value may decrease on a curve. In addition, for example, it may be considered that the residual value falls on an approximate line generated based on the transition of the winning bid price of the auction.

The residual value calculation part 311 obtains information about the winning bid price in the used vehicle auction transmitted from the facility terminal 50, and generates the residual value and the residual value table based on this winning bid price and the calculation formula stored in the auxiliary storage unit 303. The information received from the facility terminal 50 includes information about vehicles (e.g., vehicle type, grade, option, model year, traveling distance, and score) and information about winning bid prices. Hereinafter, these pieces of information are also referred to as market information. Upon receiving the market information, the residual value calculation part 311 stores the market information in the market information DB 321.

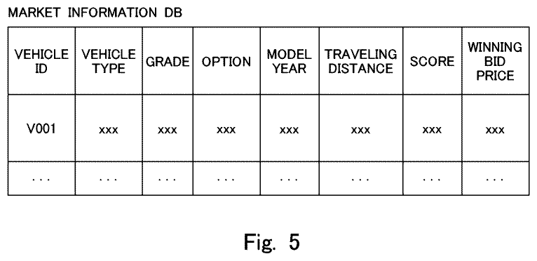

FIG. 5 is a view illustrating an example of a table configuration of the market information stored in the market information DB 321. The market information table has fields for vehicle ID, vehicle type, grade, option, model year, traveling distance, score, and winning bid price. The information stored in each of these fields of the market information DB 321 is included in the information transmitted from the facility terminal 50.

In the vehicle ID field, information for identifying each vehicle 10 is entered. In the vehicle type field, information for identifying the type of each vehicle 10 is entered. In the vehicle type field, information about each vehicle name, for example, may be entered. The degree of popularity may differ depending on the type of vehicle, which may be a factor that affects the residual value of each vehicle. Also, in the grade field, information about the grade of each vehicle 10 is entered. The grade of each vehicle 10 indicates a rank classified by equipment, performance, interior, exterior, engine, motor, price, or the like. The degree of popularity may vary depending on the grade of vehicle, which may be a factor that affects the residual value of each vehicle.

In the option field, information about options installed on each vehicle 10 is entered. The options include, for example, a navigation system, a safety driving assistance system, etc. There may also be an option to upgrade software only. The degree of popularity may vary depending on the options installed on each vehicle, which may be a factor that affects the residual value of each vehicle.

In the model year field, information about the model year of each vehicle 10 is entered. The model year of each vehicle 10 indicates the year in which the vehicle 10 was manufactured or the year in which the vehicle 10 was newly registered. Note that information about the number of years or months elapsed since the registration of each new vehicle may be entered in the model year field. The degree of progress of deterioration may differ depending on the number of years elapsed since the vehicle 10 was newly registered, which can be a factor that affects the residual value. Note that the vehicle type, grade, options, and model year may be collectively entered as a single vehicle model. In the traveling distance field, information about the traveling distance of each vehicle 10 is entered. The traveling distance may also be a factor that affects the residual value.

In the score field, information about the score of each vehicle 10 is entered. The score is a score that correlates with the condition of each vehicle 10 and is assigned according to the results of the assessment of the vehicle 10. For example, based on the size of scratches, the number of scratches, the size of dents, the number of dents, etc., present on the vehicle 10, the score is calculated such that the better the condition of the vehicle 10, the higher the score becomes. The calculation of the score is performed at the facility terminal 50. Note that, as an alternative method, the residual value calculation part 311 may calculate the score. The score may be calculated, for example, by a point deduction method from 5 points. Then, in the winning bid price field, information about the winning bid price of each vehicle 10 at the auction is entered.

Then, the residual value calculation part 311 performs the calculation of a residual value and the generation of a residual value table for each vehicle based on the information stored in the market information DB 321. Here, note that the calculation of the residual value and the generation of the residual value table are performed, for example, at predetermined time intervals. After generating the residual value table, the residual value calculation part 311 stores it in the auxiliary storage unit 303 and updates the residual value information DB 322.

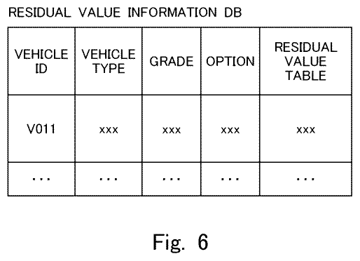

Here, FIG. 6 is a view illustrating an example of a table configuration of residual value information stored in the residual value information DB 322. A residual value information table has fields for vehicle ID, vehicle type, grade, option, and residual value table.

In the vehicle ID field, information (vehicle ID) for identifying each vehicle 10 is entered. This vehicle ID is an ID assigned to vehicles with the same vehicle type, grade, and options. Here, note that in the present embodiment, in the case of a used vehicle lease, used vehicles with a traveling distance (mileage) equal to or less than a predetermined distance and a score equal to or greater than a predetermined score is targeted for leasing, and hence, a residual value table and a monthly fee are set regardless of the traveling distance and the score. Therefore, there are no columns for traveling distance and score in the residual value information DB 322. However, the residual value table and the lease fee can also be set based on the traveling distance or the score. Also, in the present embodiment, the same residual value table is used for vehicles having the same vehicle type, grade, and options. Then, the same residual value table is set regardless of whether the vehicle is new or used. However, all of the vehicle type, grade, and options do not necessarily have to be the same. For example, in cases where the impact of grade and options on residual value is small, the same residual value table may be set regardless of grade and options, at least as long as the vehicle type is the same.

The vehicle type field, grade field, and option field contain the same information as the vehicle type field, grade field, and option field in the market information DB 321. Also, the residual value table field stores information indicating a place or location where each residual value table is stored.

Now, the fee calculation part 312 will be described. The fee calculation part 312 calculates the monthly fee and the initial cost in the first plan of the new vehicle lease, the monthly fee and the premature cancellation fee in the second plan of the new vehicle lease, and the monthly fee and the initial cost in the first plan of the used vehicle lease. These fees and costs are calculated based on the residual value table. Here, a general idea at the time of setting the monthly fees for the new vehicle lease and the used vehicle lease will be described. For example, a case will be described by way of example in which a new vehicle of vehicle type A1 illustrated in FIG. 4 is leased under a 36-month contract. In this case, the residual value of vehicle type A1 at the time of the contract is R0, and the residual value of vehicle type A1 36 months after the contract is R1. Therefore, a difference (R0-R1) occurs in the residual value of vehicle type A1 in 36 months. The monthly fee, the initial cost, and the premature cancellation fee of the lease are set so that this difference (R0-R1) can be recovered.

Also, for example, a case will be described by way of example in which a used vehicle of vehicle type A1 illustrated in FIG. 4 is leased under a 24-month contract at a time point when 36 months have elapsed since the registration of the new vehicle. In this case, the residual value of the vehicle type A1 at the time of the contract is R1, and the residual value of the vehicle type A1 24 months after the contract is R2, which is the residual value at the time when 60 months have elapsed. Therefore, a difference (R1−R2) occurs in the residual value of vehicle type A1 in 24 months. The monthly fee and the initial cost of the lease are set so that this difference (R1−R2) can be recovered.

In addition, when the vehicle 10 is leased, costs are incurred. These costs include various costs such as the cost of transporting the vehicle 10, the cost of commercializing the vehicle 10, the cost of registering the vehicle 10, the cost of vehicle inspection, the delivery cost, and the like. These costs are added to set the monthly fee, the initial cost, and the premature cancellation fee of the lease. Further, the profit of a leasing company is added to set the monthly fee, the initial cost, and the premature cancellation fee of the final lease.

For example, in the case of a 36-month lease contract for the new vehicle, the fee calculation part 312 sets the monthly fee, the initial cost, and the premature cancellation fee so that the user pays the difference between the above residual values (R0-R1), the cost, and the amount of profit set by the leasing company in 36 months. Here, note that the initial cost and the premature cancellation fee may be set to amounts that are not disadvantageous to the leasing company when the user terminates the lease prematurely. For example, the initial cost may include the expenses required to bring the vehicle into a leasable state (e.g., the cost of transporting the vehicle 10, the cost of commercializing the vehicle 10, the cost of registering the vehicle 10, the cost of vehicle inspection, the delivery cost, and the like).

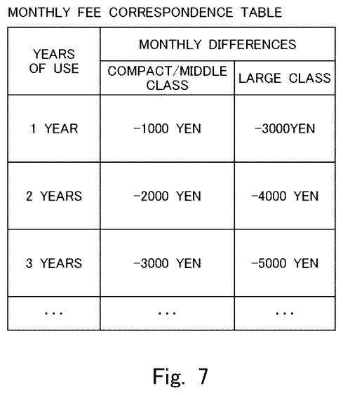

In the present embodiment, the fees for the first plan and the second plan corresponding to the new vehicle lease are calculated as described above. On the other hand, in the present embodiment, the monthly fee of the used vehicle lease is calculated based on the monthly fee of the new vehicle lease. To be specific, the monthly fee of the used vehicle lease is set so that the monthly fee of the used vehicle lease is lower by a predetermined amount than the monthly fee of the new vehicle lease. Therefore, when calculating the monthly fee of the used vehicle lease, the fee calculation part 312 first calculates a monthly fee in the first plan of the new vehicle lease, and sets, as the monthly fee of the first plan of the used vehicle lease, a monthly fee obtained by subtracting the difference stored in the monthly fee correspondence table 323 from the monthly fee of the new vehicle first calculated. In this way, based on the same residual value settings for the new and used vehicles, the fees are calculated for both the first plan in the new vehicle and the first plan in the used vehicle. FIG. 7 is a view illustrating a monthly fee correspondence table 323. The monthly fee correspondence table 323 represents differences between the monthly fees of used vehicles and the monthly fees of corresponding new vehicles. The “YEARS OF USE” indicates the number of years elapsed from the time of registration of the new vehicle, and for example, “1 YEAR” indicates a so-called one-year old vehicle. Also, the “MONTHLY DIFFERENCES” indicate decreased values from the monthly fees of the new vehicle lease. For example, “−1000 YEN” indicates that the monthly fee of a used vehicle is 1000 yen lower than that of a corresponding new vehicle.

In addition, “COMPACT/MIDDLE CLASS” and “LARGE CLASS” indicate vehicle classes. The “COMPACT/MIDDLE CLASS” indicates vehicles that are relatively small or medium in size, and the “LARGE CLASS” indicates vehicles that are relatively large. Since vehicles in the large class tend to be more expensive when new vehicles are sold than those in the compact/middle class, the monthly differences between new vehicles and used vehicles have been made larger. As a result, a large difference is not caused between the ratio of the monthly fee of used vehicles to the monthly fee of new vehicles in the “COMPACT/MIDDLE CLASS” and the ratio of the monthly fee of used vehicles to the monthly fee of new vehicles in the “LARGE CLASS”. In FIG. 7, for example, in the case of a vehicle 10 that has been used for one year and is a compact class vehicle, the monthly fee for a used vehicle is shown to be 1,000 yen lower than that for a new vehicle. In this way, the difference between the monthly fee of the first plan corresponding to the new vehicle and the monthly fee of the first plan corresponding to the used vehicle is set as a fixed amount of difference that does not depend on the type of vehicle. Also, the difference between the monthly fee of the first plan corresponding to the new vehicle and the monthly fee of the first plan corresponding to the used vehicle is set to a fixed amount of difference that does not depend on the vehicle type but depends on the vehicle class.

Here, note that in FIG. 7, the monthly differences are classified into two classes, “COMPACT/MIDDLE CLASS” and “LARGE CLASS”, according to the vehicle class, but it is not limited to this, and for example, the same monthly difference may be set for all vehicles regardless of their vehicle class, or the monthly differences may be classified into three classes, “COMPACT CLASS”, “MIDDLE CLASS” and “LARGE CLASS”, according to their vehicle class. Further, as an alternative method, instead of the vehicle class, the monthly differences may be classified into two or more categories according to the prices of new vehicles.

The monthly differences are set such that the longer the years of use, the lower the monthly fee for a used vehicle relative to a new vehicle becomes. That is, the older the model year, the lower the monthly fee is set relative to a new vehicle, so it becomes possible for the user to conclude a lease contract at a lower price. In this way, the difference between the monthly fee of the first plan corresponding to the new vehicle and the monthly fee of the first plan corresponding to the used vehicle is set to a fixed amount of difference according to the model year without depending on the vehicle type. However, if the monthly fee of the used vehicle lease is set based on the monthly fee set in the new vehicle lease, the monthly fee set in the used vehicle lease may become a deficit depending on the monthly fee of the new vehicle lease and its residual value table. In other words, the leasing company may not be able to recover part of the above difference (R1−R2), the above cost, and the profit of the leasing company. By excluding such a vehicle from the target of leasing, for example, it is possible to suppress the occurrence of a deficit. For example, the control device 31 may perform the processing of excluding the vehicle 10 that generate a deficit from the target of leasing.

Here, note that, as illustrated in FIG. 7, in the present embodiment, the monthly fee of a used vehicle is set according to the years of use and the vehicle class thereof. Therefore, the monthly amount does not vary depending on the traveling distance (mileage) of the used vehicle and the result of the assessment of the used vehicle. Therefore, in the first plan corresponding to the used vehicle, the same fee is set for the same vehicle type, regardless of the condition of the used vehicle. However, if vehicles in good condition and vehicles in bad condition coexist for the same monthly fee, the user may feel unfair. Therefore, for example, the user's sense of unfairness can be eliminated by excluding vehicles with a traveling distance equal to or greater than a predetermined distance, or vehicles with a score of less than a predetermined score, from the targets of used vehicle leasing. The processing of excluding vehicles with a traveling distance equal to or greater than a predetermined distance or vehicles with a score less than a predetermined score from the targets of used vehicle leasing may be performed by the control device 31 or by the facility terminal 50 based on the input of the assessor who performed the assessment of the vehicle 10.

Then, the plan presentation part 313 presents fee plans to the user. Here, in cases where the user wishes to lease a new vehicle, the plan presentation part 313 presents a first plan and a second plan. At this time, a monthly fee and an initial cost in the first plan calculated by the fee calculation part 312 are presented together with a monthly fee and a premature cancellation fee in the second plan. In addition, in the case of the second plan, the monthly fee and the premature cancellation fee may be presented according to a contract period. For the contract period, for example, 3 years, 5 years, or 7 years may be selectable.

The contract part 314 executes processing for concluding a contract when a lease application is received from the user terminal 40. Known techniques can be used for this processing.

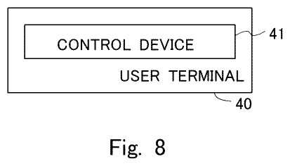

Next, the functions of the user terminal 40 will be described. FIG. 8 is a diagram illustrating an example of a functional configuration of the user terminal 40. The user terminal 40 includes a control device 41 as its functional component. The processor 401 of the user terminal 40 executes the processing of the control device 41 by a computer program on the main storage unit 402.

The user terminal 40 can access a website on the Internet via a browser. The control device 41 accesses a lease site according to an input of the user to the input unit 404. At this time, the control device 41 transmits a request for displaying lease plans to the server 30. In addition, the control device 41 displays a page for selecting which of a new vehicle or a used vehicle is desired to be leased, in accordance with a command transmitted from the server 30. When the user taps a button corresponding to new vehicle leasing or a button corresponding to used vehicle leasing set on this page, the control device 41 transmits the information corresponding to the user's selection to the server 30.

Also, the control device 41 displays a page for selecting a vehicle type in accordance with a command transmitted from the server 30. Then, when the user taps a button for selecting a vehicle type set on this page, the control device 41 transmits the information corresponding to the selection of the user to the server 30. Further, in cases where the user selects a new vehicle lease, the control device 41 displays information about a first plan and a second plan in accordance with a command transmitted from the server 30. On the other hand, when the user selects a used vehicle lease, the control device 41 displays information about the first plan according to a command transmitted from the server 30.

Further, the control device 41 transmits information for concluding a lease contract to the server 30 according to an input of the user. At this time, for example, information about the plan selected by the user, the name, the address, the telephone number, the e-mail address, the credit card number, etc., of the user is transmitted to the server 30.

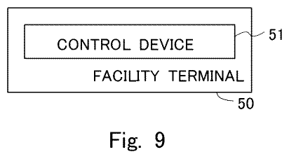

Next, the functions of the facility terminal 50 will be described. FIG. 9 is a diagram illustrating an example of a functional configuration of the facility terminal 50. The facility terminal 50 includes a control device 51 as its functional component. The processor 501 of the facility terminal 50 executes the processing of the control device 51 by a computer program on the main storage unit 502.

The control device 51 obtains the information (market information) of the vehicle 10 that have been won at the auction, and transmits it to the server 30. This information includes market information stored in the market information DB 321. Here, in the auction, information about vehicles (e.g., vehicle type, grade, model year, traveling distance, and score) is presented to bidders, so that the bidders can each make a bid based on these pieces of information. Then, the bidder who has submitted a bid at the highest price becomes a successful bidder, and a winning bid price is determined. When a used vehicle is successfully bid, the control device 51 associates the winning bid price at that time with the information about that vehicle, stores the information in the auxiliary storage unit 503, and further transmits it to the server 30.

The control device 51 calculates the score of the vehicle 10 that has been successfully bid at the auction and the score of a vehicle 10 that is to be a target for leasing. For example, a calculation formula for calculating a score based on the size of scratches, the number of scratches, the size of dents, the number of dents, etc., present on the vehicle 10 has been stored in the auxiliary storage unit 503 of the facility terminal 50. Then, when an assessor at the facility inputs the result of the assessment, including the size of scratches, the number of scratches, the size of dents, the number of dents, etc., into the facility terminal 50, the control device 51 calculates the scores using the calculation formula. Note that known techniques can be used to calculate the scores.

In addition, the control device 51 transmits to the server 30 information about the condition of the vehicle 10 that may be a target for used vehicle leasing. This information includes the vehicle type, the grade, the model year, the traveling distance, the score, etc. This information is entered into the facility terminal 50 via the input unit 504 of the facility terminal 50 by the assessor, for example, and stored in the auxiliary storage unit 503.

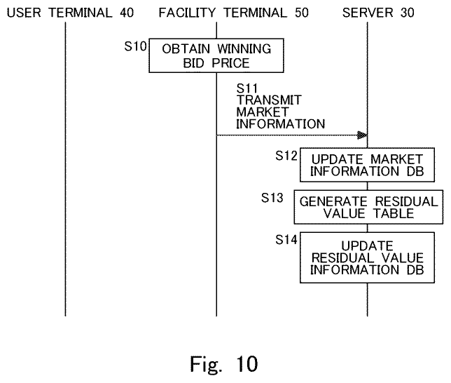

Next, the flow of processing for generating a residual value table in the server 30 will be described. FIG. 10 is a sequence diagram illustrating the processing for generating the residual value table. In FIG. 10, the facility terminal 50 obtains information about winning bid prices in an auction of used vehicles. When a used vehicle is successfully bid, the facility terminal 50 obtains its winning bid price at that time by associating it with the information about that vehicle (S10), and stores it in the auxiliary storage unit 503. Further, the information about this winning bid price is transmitted to the server 30 as a market information together with the information about the vehicle (S11).

The server 30, which receives the market information, updates the market information DB 321 by storing the market information in the market information DB 321 (S12). Also, at the server 30, a residual value table for each vehicle based on the information stored in the market information DB 321 and the calculation formula stored in the auxiliary storage unit 303 (S13). Here, note that this residual value table may be generated at each predetermined time period (e.g., every half year), or may be generated after a predetermined number of market information have been received. The residual value table may be generated, for example, by using a known technique. When the residual value table is generated, the residual value information DB 322 is updated by inputting the storage location of the residual value table into the residual value information DB 322 of the server 30 (S14).

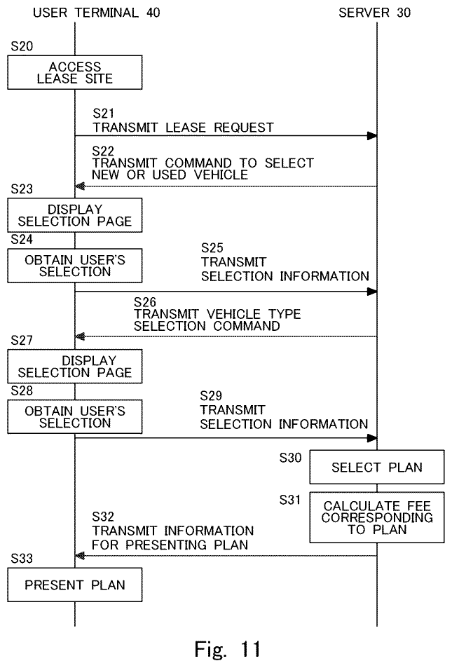

Now, the processing of the system 1 when a user accesses a lease site will be described. FIG. 11 is a sequence diagram illustrating the processing of the system 1 when a user accesses a lease site. Here, note that the following explanation will be made on the assumption that necessary information has been stored in the residual value information DB 322. The user makes a predetermined input to a web browser installed on the user terminal 40. This causes the user terminal 40 to access the lease site (S20). At this time, a lease request is generated at the user terminal 40, and the lease request is transmitted from the user terminal 40 to the server 30.

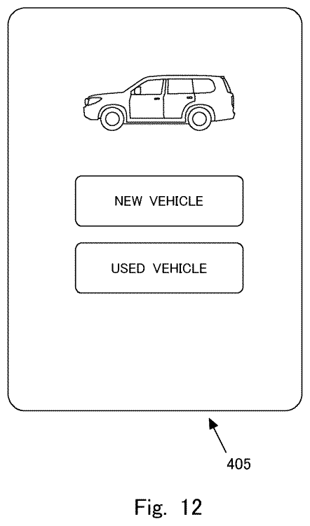

In response to receiving the lease request, the server 30 transmits, to the user terminal 40, a command to display an image for allowing the user to select a new vehicle or a used vehicle (S22). This command also includes a command to transmit the result of the selection to the server 30. At the user terminal 40, a page for selecting either a new vehicle or a used vehicle is displayed according to the command received from the server 30 (S23). Here, FIG. 12 is a view illustrating an example of the page for allowing the user to select either a new vehicle or a used vehicle. The user can select a new vehicle lease by tapping a “NEW VEHICLE” button, or a used vehicle lease by tapping a “USED VEHICLE” button. Based on which button the user taps on this page, the user terminal 40 obtains the selection of the user (S24). The user terminal 40 generates selection information according to the button tapped by the user and transmits the selection information to the server 30 (S25).

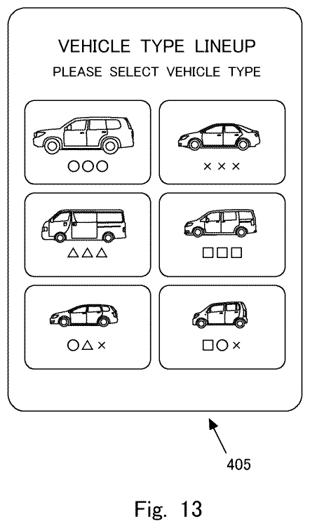

Then, the server 30 transmits, to the user terminal 40, a command to display an image for allowing the user to select a vehicle type (S26). This command also includes a command to transmit the result of the selection to the server 30. At this time, the server 30 may transmit, to the user terminal 40, information about a list of selectable vehicle types and a command to display the list of vehicle types on the user terminal 40. At the user terminal 40, a page for selecting a vehicle type is displayed according to the command received from the server 30 (S27). Here, FIG. 13 is a view illustrating an example of the page for allowing the user to select a vehicle type. The vehicle types displayed on this page are those that can be leased and are stored in the auxiliary storage unit 303. A list of vehicle types corresponding to the new or used vehicle selected by the user is displayed, and when the user taps a button on which any of the vehicle types is drawn, the user terminal 40 obtains the selection of the user (S28). At this time, for example, the user taps the vehicle type that the user wants to lease from among a plurality of vehicle types displayed in the list of vehicle types. Thus, selection information is generated according to the tapped vehicle type, and is transmitted to the server 30 (S29).

In response to obtaining the information about the vehicle type selected by the user, the server 30 selects a plan based on the information that the user has selected either a new vehicle or a used vehicle (S30). At this time, in cases where the user has selected a new vehicle, the server 30 selects a first plan and a second plan, and in cases where the user has selected a used vehicle, the server 30 selects only a first plan. Then, the server 30 calculates a fee according to the plan (S31). This fee includes the initial cost and the monthly fee in the first plan and the premature cancellation fee and the monthly fee in the second plan. The server 30 calculates the fees according to the plans in the case of the new vehicle based on the residual value table of the corresponding vehicle type stored in the residual value information DB 322. On the other hand, in cases where the user has selected a used vehicle, the server 30 calculates a monthly fee corresponding to the used vehicle based on the above monthly fee according to the first plan corresponding to the new vehicle and the monthly fee correspondence table 323.

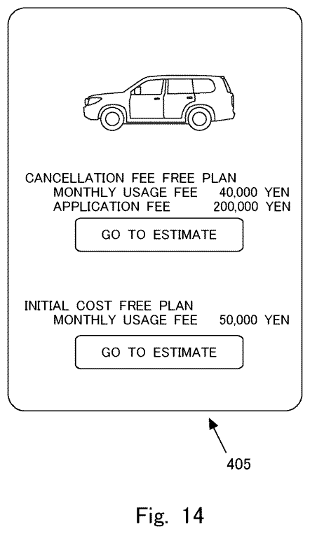

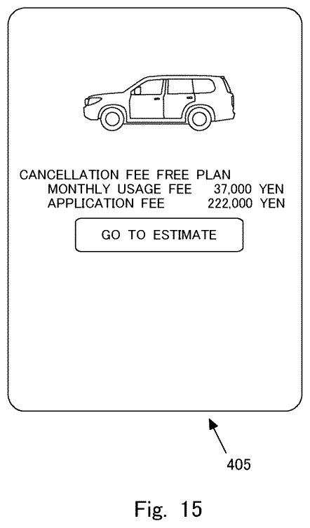

The server 30, which has calculated the fee corresponding to the plan, transmits to the user terminal 40 a command to display an image for presenting the plan to the user terminal 40 (S32). At this time, the server 30 may transmit, to the user terminal 40, a command for displaying, on the user terminal 40, the vehicle type selected by the user, the fee plan corresponding to this vehicle type, and a list of the fees to be paid by the user. In the user terminal 40, which has received this information, the plan is displayed on the display 405, so that the plan is presented to the user. FIG. 14 is a view illustrating an example of the image to be displayed on the display 405 of the user terminal 40 in cases where the user selects the new vehicle. In this way, information about the fees to be paid by the user in each of the cancellation fee free plan (first plan) and the initial cost free plan (second plan) is displayed. Here, note that the premature cancellation fee for the second plan in the new vehicle lease is determined according to, for example, the number of months remaining in the contract or the like, and hence may not be displayed at this time point. FIG. 15 is a view illustrating an example of the image to be displayed on the display 405 of the user terminal 40 in cases where the user selects the used vehicle. In this way, information about the fees to be paid by the user in the cancellation fee free plan (first plan) is displayed. As a result, only the first plan is presented to the user.

Here, note that the fees illustrated in FIGS. 14 and 15 may be, for example, fees corresponding to vehicles in which no option is installed at the standard grade. Then, for example, by tapping a “GO TO ESTIMATE” button, the user may turn to a new page in which he or she can select a grade and options, and the fee may be recalculated based on the selections made on this page. In addition, in the case of a used vehicle lease, the user may further be able to select a model year, so that the fee may be recalculated according to the model year thus selected.

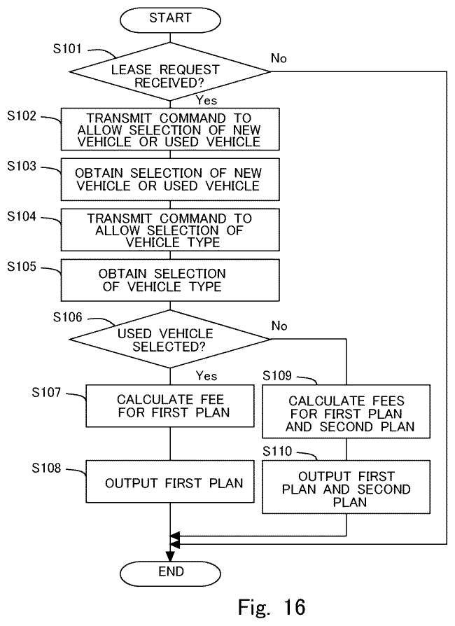

Next, the processing of presenting a fee plan to the user by the server 30 will be described. FIG. 16 is a flowchart of processing for displaying fee plans on the display 405 of the user terminal 40 according to the first embodiment. The processing illustrated in FIG. 16 is executed at predetermined time intervals at the server 30. Note that the following explanation will be made on the assumption that necessary information has been entered in the residual value information DB 322 and the monthly fee correspondence table 323. In addition, the following explanation will also be made on the assumption that all the processing executed by the residual value calculation part 311, the fee calculation part 312, the plan presentation part 313, and the contract part 314 is executed by the control device 31.

In step S101, the control device 31 determines whether or not a lease request has been received from the user terminal 40. For example, when the user taps a button for displaying a lease plan, a button for applying for a lease, a button for requesting an estimate of the fees required for a lease, or the like on a web page displayed on the display 405 of the user terminal 40, a lease request is transmitted from the user terminal 40 to the server 30. In addition, as an alternative method, it may be determined that a lease request has been transmitted from the user terminal 40 to the server 30 by accessing a predetermined web page from a web browser on the user terminal 40. When an affirmative determination is made in step S101, the processing or routine proceeds to step S102, whereas when a negative determination is made, this routine is ended.

In step S102, the control device 31 generates a command to display an image for allowing the user to select a new vehicle or a used vehicle on the display 405 of the user terminal 40, and transmits the command to the user terminal 40. In the user terminal 40 that has received this command, the image illustrated in FIG. 12 is displayed, for example. Then, when the user taps either a new vehicle button or a used vehicle button, information about whether the user has selected a new vehicle or a used vehicle is transmitted from the user terminal 40 to the server 30.

In step S103, the control device 31 obtains, from the user terminal 40, information about whether the user has selected a new vehicle or a used vehicle. The information thus obtained is stored in the auxiliary storage unit 303.

In step S104, the control device 31 generates a command to display an image for allowing the user to select a vehicle type on the display 405 of the user terminal 40, and transmits the command to the user terminal 40. In the user terminal 40 that has received this command, the image illustrated in FIG. 13 is displayed, for example. When the user taps a button for any vehicle type in the list of the vehicle types displayed, information about the vehicle type thus selected is transmitted from the user terminal 40 to the server 30.

In step S105, the control device 31 obtains, from the user terminal 40, information about the vehicle type selected by the user. The information thus obtained is stored in the auxiliary storage unit 303. Note that in the present embodiment, a new vehicle or a used vehicle is first selected, and then a vehicle type is selected, but this order may be reversed. That is, a vehicle type may be selected first, and then a new vehicle or a used vehicle may be selected. As a further alternative, the selection of a new vehicle or a used vehicle and the selection of a vehicle type may be made at the same time on the same web page.

In step S106, the control device 31 determines whether or not the user has selected a used vehicle. That is, it is determined whether or not information about the selection of a used vehicle has been obtained from the user terminal 40, in step S103. When an affirmative determination is made in step S106, the processing proceeds to step S107, whereas when a negative determination is made, the processing proceeds to step S109.

In step S107, the control device 31 calculates a fee for the first plan corresponding to the used vehicle. That is, the initial cost and monthly amount of the first plan to be applied to the vehicle type selected by the user are calculated. In step S108, the control device 31 generates a command to display, on the display 405 of the user terminal 40, the fact that the fee plan is the first plan (cancellation fee free plan), as well as the initial cost and the monthly fee of the first plan, and transmits the command to the user terminal 40. In the user terminal 40 that has received this command, the image illustrated in FIG. 15 is displayed, for example. As a result, the first plan corresponding to the used vehicle is presented to the user.

On the other hand, in step S109, the control device 31 calculates a fee for each of the first plan and the second plan corresponding to the new vehicle. That is, the initial cost and the monthly fee of the first plan to be applied to the vehicle type selected by the user and the premature cancellation fee and the monthly fee of the second plan to be applied to the vehicle type selected by the user are calculated. In step S110, the control device 31 generates a command to display, on the display 405 of the user terminal 40, the initial cost and the monthly fee of the first plan and the premature cancellation fee and the monthly fee of the second plan, and transmits the command to the user terminal 40. In the user terminal 40 that has received this command, the image illustrated in FIG. 14 is displayed, for example. As a result, the first plan and the second plan corresponding to the new vehicle is presented to the user. Here, note that the information to be transmitted at this time includes a command to display, on the display 405 of the user terminal 40, the fact that the user can select either the first plan (cancellation fee free plan) or the second plan (initial cost free plan) as the fee plan, and the initial cost and the monthly fee when the first plan is selected, and the premature cancellation fee and the monthly fee when the second plan is selected.

Thereafter, when the user taps the “GO TO ESTIMATE” button illustrated in FIGS. 14 and 15, a request to create an estimate is transmitted from the user terminal 40. Further, when the user terminal 40 receives an input for agreeing with the estimate, information about the application for a lease is transmitted from the user terminal 40 to the server 30. Then, the control device 31 executes the processing of concluding a lease contract. At this time, in the case of the new vehicle, the lease contract is concluded with either the first plan or the second plan, whereas in the case of the used vehicle, the lease contract is concluded only with the first plan. Since a known technique can be adopted for the above processing, the description thereof will be omitted.

In this way, by presenting the first plan and the second plan to the users who desire a lease contract and who desire a new vehicle, it is possible to increase options for the users. Here, a premature cancellation fee is incurred when the second plan is contracted for a new vehicle, but users who contract for a new vehicle, which costs more per month than a used vehicle, tend to be financially well-off users, so they can switch to other vehicles even if a premature cancellation fee is incurred. Therefore, by expanding the choice of options, more users can be captured.

On the other hand, by presenting only the first plan to users who desire a lease contract and who desire a used car, no premature cancellation fee will be incurred even if the contract is canceled before the end of the lease term. Therefore, the users can switch to other vehicles relatively easily. Here, the users who select used vehicle leasing tend not to switch to other vehicles when a premature cancellation fee is incurred. Therefore, it is possible to encourage switching to other vehicles by not incurring a premature cancellation fee. By encouraging switching to other vehicles, for example, the opportunity to make a change to a vehicle with a higher monthly fee increases, and further, a change to a new vehicle can still be considered. Therefore, it is possible for the leasing company to increase its profit. In addition, from the viewpoint of the users, more vehicles can be experienced, so that the degree of satisfaction of the users becomes higher.

### Second Embodiment

In the first embodiment, when a user selects a new vehicle or a used vehicle, and further selects a vehicle type, a first plan and a second plan corresponding to the new vehicle or a first plan corresponding to the used vehicle are displayed. On the other hand, in a second embodiment, a first plan and a second plan corresponding to a new vehicle, and a first plan corresponding to a used vehicle are displayed on the same screen.

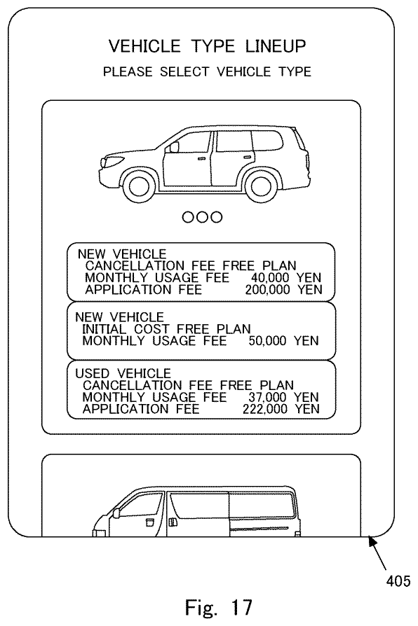

FIG. 17 is a view illustrating an example of a web page shown on the display 405 of the user terminal 40 for selecting a fee plan. In the example illustrated in FIG. 17, the respective fees of first plans corresponding to new vehicles, second plans corresponding to new vehicles, and first plans corresponding to used vehicles, of respective vehicle types are displayed. By scrolling the screen, it is also possible to display the respective fees of a first plan corresponding to a new vehicle, a second plan corresponding to a new vehicle, and a first plan corresponding to a used vehicle, all in another vehicle type.

Here, note that the fees illustrated in FIG. 17 may be, for example, fees corresponding to vehicles in which no option is installed at the standard grade. Then, for example, by tapping a button corresponding to any of the fee plans, the user may turn to a page in which he or she can select a grade and options, and the fee may be recalculated based on the selections made on this page. In addition, in the case of a used vehicle lease, the user may further be able to select a model year, so that the fee may be recalculated according to the model year thus selected.

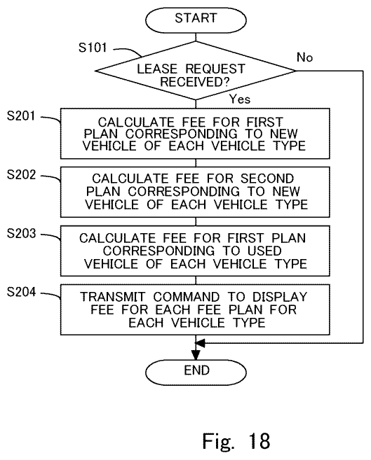

Next, the processing of presenting fee plans to the user by the server 30 will be described. FIG. 18 is a flowchart of processing for displaying fee plans on the display 405 of the user terminal 40 according to the second embodiment. The processing illustrated in FIG. 18 is executed at predetermined time intervals at the server 30. Note that the following explanation will be made on the assumption that necessary information has been entered in the residual value information DB 322 and the monthly fee correspondence table 323. Also, the following explanation will be made on the assumption that all the processing executed by the residual value calculation part 311, the fee calculation part 312, the plan presentation part 313, and the contract part 314 is executed by the control device 31. In addition, the steps in which the same processing is performed as in the flowchart illustrated in FIG. 16 are denoted by the same reference signs, and the description thereof will be omitted. The flowchart illustrated in FIG. 18 is executed instead of the flowchart illustrated in FIG. 16.

In the flowchart illustrated in FIG. 18, when an affirmative determination is made in step S101, the processing proceeds to step S201. In step S201, the control device 31 calculates the fee of a first plan corresponding to a new vehicle of each vehicle type that can be leased. That is, the initial cost and the monthly fee of the first plan applied to each vehicle type is calculated for each vehicle type. Note that information about the vehicle types that can be leased has been stored in the auxiliary storage unit 303. In step S202, the control device 31 calculates the fee of a second plan corresponding to the new vehicle of each vehicle type that can be leased. That is, the premature cancellation fee and the monthly fee of the second plan applied to each vehicle type is calculated for each vehicle type. Further, in step S203, the control device 31 calculates the fee of a first plan corresponding to a used vehicle of each vehicle type that can be leased. That is, the initial cost and the monthly fee of the first plan applied to each vehicle type are calculated for each vehicle type. Then, in step S204, the control device 31 transmits, to the user terminal 40, a command to display selectable vehicle types, the fee of the first plan corresponding to the new vehicle in each vehicle type, the fee of the second plan corresponding to the new vehicle in each vehicle type, and the fee of the first plan corresponding to the used vehicle in each vehicle type. As a result, for example, the image illustrated in FIG. 17 is displayed on the display 405 of the user terminal 40.

In this way, too, by presenting first plans and second plans to the users who desire a lease contract and who desire a new vehicle, it is possible to increase options for the users. On the other hand, by presenting only first plans to the users who desire a lease contract and who desire a used vehicle, the users can switch to another vehicle relatively easily.

### Third Embodiment

In the first embodiment, the user is first caused to select either a new vehicle or a used vehicle, and a first plan and a second plan are output according to the selection of the user. On the other hand, in a third embodiment, the user is first caused to select either a first plan or a second plan, and in cases where the user selects the first plan, the fees of first plans corresponding to a new vehicle and a used vehicle are output, respectively, whereas in cases where the second plan is selected, the fee of the second plan corresponding to a new vehicle is output. Even in this case, it can be said that the first plan and the second plan are output as lease plans for the new vehicle, and that only the first plan is output as a lease plan for the used vehicle.

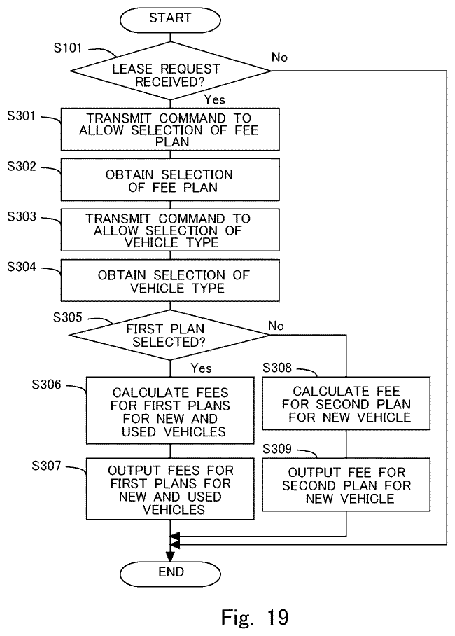

Next, the processing of presenting fee plans to the user by the server 30 will be described. FIG. 19 is a flowchart of processing for displaying fee plans on the display 405 of the user terminal 40 according to a third embodiment. The processing illustrated in FIG. 19 is executed at predetermined time intervals at the server 30. Note that the following explanation will be made on the assumption that necessary information has been entered in the residual value information DB 322 and the monthly fee correspondence table 323. Also, the following explanation will be made on the assumption that all the processing executed by the residual value calculation part 311, the fee calculation part 312, the plan presentation part 313, and the contract part 314 is executed by the control device 31. In addition, the steps in which the same processing is performed as in the flowchart illustrated in FIG. 16 are denoted by the same reference signs, and the description thereof will be omitted.

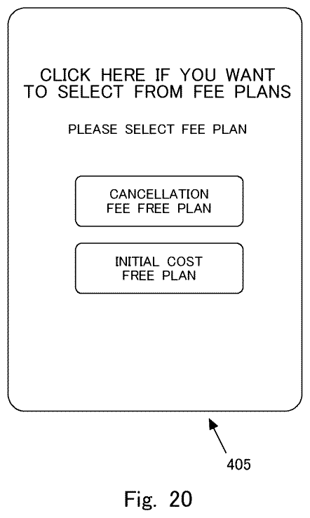

In the flowchart illustrated in FIG. 19, when an affirmative determination is made in step S101, the processing proceeds to step S301. In step S301, the control device 31 generates a command to display an image for allowing the user to select a first plan and a second plan on the display 405 of the user terminal 40, and transmits the command to the user terminal 40. In the user terminal 40 that has received this command, an image illustrated in FIG. 20 is displayed, for example. FIG. 20 is a view illustrating an example of a page for allowing the user to select, as a fee plan, either a first plan (cancellation fee free plan) or a second plan (initial cost free plan). The user can select the first plan by tapping a “CANCELLATION FEE FREE PLAN” button, or the second plan by tapping an “INITIAL COST FREE PLAN” button. Based on which button the user has tapped on this page, the user terminal 40 obtains the selection of the user. Then, the user terminal 40 generates selection information according to the button tapped by the user, and transmits the selection information to the server 30.

In step S302, the control device 31 obtains, from the user terminal 40, information about whether the user has selected the first plan or the second plan. The information thus obtained is stored in the auxiliary storage unit 303.

In step S303, the control device 31 generates a command to display an image for allowing the user to select a vehicle type on the display 405 of the user terminal 40, and transmits the command to the user terminal 40. In the user terminal 40 that has received this command, the image illustrated in FIG. 13 is displayed, for example. When the user taps a button for any vehicle type in the list of the vehicle types displayed, information about the vehicle type thus selected is transmitted from the user terminal 40 to the server 30.

In step S304, the control device 31 obtains, from the user terminal 40, information about the vehicle type selected by the user. The information thus obtained is stored in the auxiliary storage unit 303.

In step S305, the control device 31 determines whether or not the user has selected the first plan. That is, it is determined whether or not information about the selection of the first plan has been obtained from the user terminal 40, in step S302. When an affirmative determination is made in step S305, the processing proceeds to step S306, whereas when a negative determination is made, the processing proceeds to step S308.

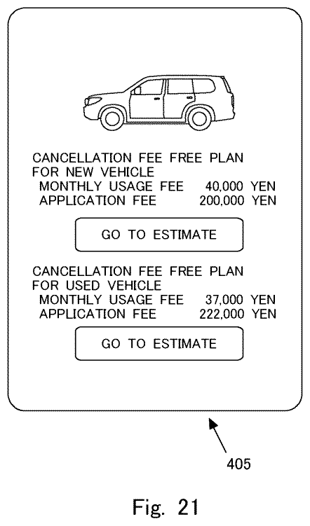

In step S306, the control device 31 calculates a fee for a first plan corresponding to a new vehicle and a fee for a first plan corresponding to a used vehicle, respectively. That is, the initial cost and the monthly fee of the first plan to be applied to the vehicle type selected by the user are calculated. In step S307, the control device 31 generates a command to display, on the display 405 of the user terminal 40, the fact that the fee plan is the first plan (cancellation fee free plan), the initial cost and the monthly fee of the first plan corresponding to the new vehicle, and the initial cost and the monthly fee of the first plan corresponding to the used vehicle, and transmits the command to the user terminal 40. In the user terminal 40 that has received this command, an image illustrated in FIG. 21 is displayed, for example. FIG. 21 is a view illustrating an example of the image shown on the display 405 of the user terminal 40 when the user selects the first plan. In this way, information is displayed about the fees to be paid by the user in the cancellation fee free plan (first plan) of the new vehicle and in the cancellation fee free plan (first plan) of the used vehicle, respectively. As a result, the first plans corresponding to the new vehicle and the used vehicle, respectively, are presented to the user.

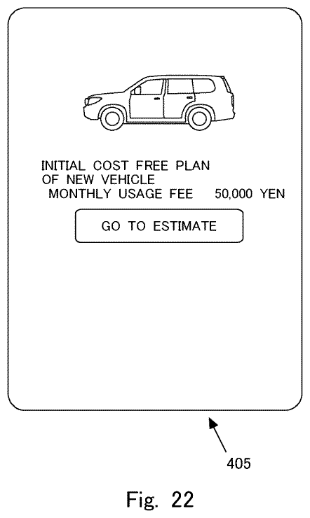

On the other hand, in step S308, the control device 31 calculates fees for a second plan corresponding to a new vehicle. That is, the premature cancellation fee and the monthly fee for the second plan of the new vehicle to be applied to the vehicle type selected by the user are calculated. In step S309, the control device 31 generates a command to display the premature cancellation fee and the monthly fee of the second plan corresponding to the new vehicle on the display 405 of the user terminal 40, and transmits the command to the user terminal 40. In the user terminal 40 that has received this command, an image illustrated in FIG. 22 is displayed, for example. FIG. 22 is a view illustrating an example of the image shown on the display 405 of the user terminal 40 when the user selects the second plan. In this way, information about the fees to be paid by the user in the initial cost free plan (second plan) for the new vehicle is displayed. As a result, the second plan corresponding to the new vehicle is presented to the user.

Thereafter, when the user taps the “GO TO ESTIMATE” button illustrated in FIGS. 21 and 22, a request to create an estimate is transmitted from the user terminal 40 to the server 30. Further, when the user terminal 40 receives an input for agreeing with the estimate, information about the application for a lease is transmitted from the user terminal 40 to the server 30. Then, the control device 31 executes the processing of concluding a lease contract. At this time, in the case of the new vehicle, the lease contract is concluded with either the first plan or the second plan, whereas in the case of the used vehicle, the lease contract is concluded only with the first plan. Since a known technique can be adopted for the above processing, the description thereof will be omitted.

In this way, too, by presenting the first plans and the second plan to the user who desires a lease contract and who desires a new vehicle, it is possible to increase options for the user. On the other hand, by presenting only the first plans to the user who desires a lease contract and who desires a used vehicle, the user can switch to another vehicle relatively easily.

### OTHER EMBODIMENTS

The above-described embodiments are merely examples, but the present disclosure can be implemented with appropriate modifications without departing from the spirit thereof.

The processing and/or means (devices, units, etc.) described in the present disclosure can be freely combined and implemented as long as no technical contradiction occurs.

The processing described as being performed by one device or unit may be shared and performed by a plurality of devices or units. Alternatively, the processing described as being performed by different devices or units may be performed by one device or unit. In a computer system, a hardware configuration (server configuration) for realizing each function thereof can be changed in a flexible manner. For example, the facility terminal 50 may have a part or all of the functions of the server 30, or the server 30 may have a part or all of the functions of the facility terminal 50.

The present disclosure can also be realized by supplying to a computer a computer program in which the functions described in the above-described embodiments are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read-only memory (ROM), a random-access memory (RAM), an EPROM, an EEPROM, a magnetic card, a flash memory, an optical card, or any type of medium suitable for storing electronic commands or instructions.

What is claimed is:

1. An information processing apparatus comprising a controller configured to:
output, as lease plans for a new vehicle, a first plan in which an initial cost is incurred but a premature cancellation fee is not incurred and a second plan in which an initial cost is not incurred but a premature cancellation fee is incurred; and
output only the first plan as a lease plan for a used vehicle.

2. The information processing apparatus according to claim 1, wherein
the controller is configured to set a difference between an amount to be paid at predetermined intervals in the first plan corresponding to the new vehicle and an amount to be paid at the predetermined intervals in the first plan corresponding to the used vehicle to a fixed amount of difference, regardless of the type of vehicle.

3. The information processing apparatus according to claim 1, wherein
the controller is configured to set a difference between an amount to be paid at predetermined intervals in the first plan corresponding to the new vehicle and an amount to be paid at the predetermined intervals in the first plan corresponding to the used vehicle to a fixed amount of difference, regardless of the type of vehicle but according to the class of vehicle.

4. The information processing apparatus according to claim 1, wherein
the controller is configured to set a difference between an amount to be paid at predetermined intervals in the first plan corresponding to the new vehicle and an amount to be paid at the predetermined intervals in the first plan corresponding to the used vehicle to a fixed amount of difference, regardless of the type of vehicle but according to the model year.

5. The information processing apparatus according to claim 2, wherein
the controller is configured to increase the fixed amount of difference as the model year of the used vehicle is older, in the case of the same vehicle type in the first plan corresponding to the used vehicle.

6. The information processing apparatus according to claim 1, wherein
the controller is configured to output the first plan in the new vehicle and the first plan in the used vehicle, by setting as a residual value a price of each vehicle at the expiration of a lease contract, and calculating and outputting a fee in each of the first plan in the new vehicle and the first plan in the used vehicle based on the same residual value setting for the new vehicle and the used vehicle.

7. The information processing apparatus according to claim 1, wherein
the controller is configured to set the same fee, in the case of the same type of vehicle in the first plan corresponding to the used vehicle, regardless of the condition of the used vehicle.

8. The information processing apparatus according to claim 1, further comprising:
a memory configured to store:
a residual value for predicting a future valuation corresponding to the new vehicle;
a calculation formula for calculating, based on the residual value, a fee in the first plan and a fee in the second plan, both corresponding to the new vehicle; and
information about a difference between the fee for the first plan corresponding to the new vehicle and the fee for the first plan corresponding to the used vehicle.

9. The information processing apparatus according to claim 1, further comprising:
a communication unit configured to communicate with a terminal of a user; wherein
the controller is configured to:
output the first plan and the second plan by transmitting, in response to receiving a request to display lease plans from the terminal of the user via the communication unit, a command to display, as lease plans for the new vehicle, an image corresponding to the first plan and the second plan on the terminal of the user, to the terminal of the user via the communication unit; and
output only the first plan by transmitting to the terminal of the user via the communication unit a command to display, as a lease plan for the used vehicle, an image corresponding to only the first plan on the terminal of the user.

10. The information processing apparatus according to claim 8, further comprising:
a communication unit configured to communicate with the terminal of the user; wherein
the controller is configured to:
transmit, in response to receiving a request to display a lease plan from the terminal of the user via the communication unit, to the terminal of the user a command to display, on the terminal of the user, an image that allows the user to select a lease of either the new vehicle or the used vehicle, and a command to transmit information about the selection of the lease entered by the user into the terminal of the user;
calculate, in response to receiving information about the user's selection of the lease of the new vehicle from the terminal of the user, a fee corresponding to the new vehicle for each of the first plan and the second plan based on the residual value and the calculation formula stored in the memory;
output the first plan and the second plan by transmitting, to the terminal of the user, a command to display, on the terminal of the user, an image corresponding to the calculated fee for each of the first plan and the second plan;
calculate, in response to receiving information about the user's selection of the lease of the used vehicle from the terminal of the user via the communication terminal, a fee corresponding to the new vehicle for the first plan based on the residual value and the calculation formula stored in the memory;
calculate a fee corresponding to the used vehicle for the first plan based on the calculated fee corresponding to the new vehicle and the information about the difference stored in the memory; and
output only the first plan by transmitting, to the terminal of the user, a command to display, on the terminal of the user, an image corresponding to the calculated fee for the first plan.

11. The information processing apparatus according to claim 10, wherein
the communication unit is further configured to communicate with a terminal that manages the buying and selling of the used vehicle; and wherein
the memory is further configured to:
store first information about a transaction amount of the used vehicle received from the terminal that manages the buying and selling of the used vehicle, and a second calculation formula for calculating the residual value based on the first information;
the controller is configured to:
receive the first information from the terminal that manages the buying and selling of the used vehicle, to store the first information thus received in the memory;
calculate the residual value based on the first information and the second calculation formula; and
store the residual value thus calculated in the memory.

12. An information processing method comprising:
outputting, by a computer, as lease plans for a new vehicle, a first plan in which an initial cost is incurred but a premature cancellation fee is not incurred and a second plan in which an initial cost is not incurred but a premature cancellation fee is incurred; and
outputting only the first plan as a lease plan for a used vehicle.

13. The information processing method according to claim 12, further comprising:
setting, by the computer, a difference between an amount to be paid at predetermined intervals in the first plan corresponding to the new vehicle and an amount to be paid at the predetermined intervals in the first plan corresponding to the used vehicle to a fixed amount of difference, regardless of the type of vehicle.

14. The information processing method according to claim 12, further comprising:
setting, by the computer, a difference between an amount to be paid at predetermined intervals in the first plan corresponding to the new vehicle and an amount to be paid at the predetermined intervals in the first plan corresponding to the used vehicle to a fixed amount of difference, regardless of the type of vehicle but according to the class of vehicle.

15. The information processing method according to claim 12, further comprising:
setting, by the computer, a difference between an amount to be paid at predetermined intervals in the first plan corresponding to the new vehicle and an amount to be paid at the predetermined intervals in the first plan corresponding to the used vehicle to a fixed amount of difference, regardless of the type of vehicle but according to the model year.

16. The information processing method according to claim 13, further comprising:
increasing, by the computer, the fixed amount of difference as the model year of the used vehicle is older, in the case of the same vehicle type in the first plan corresponding to the used vehicle.

17. The information processing method according to claim 12, further comprising:
outputting, by the computer, the first plan in the new vehicle and the first plan in the used vehicle, by setting as a residual value a price of each vehicle at the expiration of a lease contract, and calculating and outputting a fee in each of the first plan in the new vehicle and the first plan in the used vehicle based on the same residual value setting for the new vehicle and the used vehicle.

18. The information processing method according to claim 12, further comprising:
setting, by the computer, the same fee, in the case of the same type of vehicle in the first plan corresponding to the used vehicle, regardless of the condition of the used vehicle.

19. The information processing method according to claim 12, further comprising:
outputting, by the computer, the first plan and the second plan by transmitting, in response to receiving a request to display lease plans from the terminal of the user via the communication unit, a command to display, as the lease plans for the new vehicle, an image corresponding to the first plan and the second plan on the terminal of the user, to the terminal of the user via the communication unit; and
outputting only the first plan by transmitting to the terminal of the user via the communication unit a command to display, as the lease plan for the used vehicle, an image corresponding to only the first plan on the terminal of the user.

20. A system comprising:
a terminal of a user;
a server including a controller configured to transmit lease plans for a new vehicle or a lease plan for a used vehicle to the terminal of the user; wherein
the controller is configured to:
transmit, as the lease plans for the new vehicle, to the terminal of the user a first plan in which an initial cost is incurred but a premature cancellation fee is not incurred, and a second plan in which an initial cost is not incurred but a premature cancellation fee is incurred; and
transmit, as the lease plan for the used vehicle, only the first plan to the terminal of the user.
